(19) United States
(12) Patent Application Publication
(10) Pub. No.: US 2012/0169990 A1
(43) Pub. Date: Jul. 5, 2012

(54) ELECTRONIC EYEWEAR AND FOOTWEAR

(76) Inventor: Tracey E. Burnstein, Bloomfield Hills, MI (US)

(21) Appl. No.: 12/985,189

(22) Filed: Jan. 5, 2011

(51) Int. Cl. G02C 11/00; A43B 23/24; G02C 5/20

(52) U.S. Cl. 351/115; 36/136

(57) ABSTRACT

A eyeglasses assembly comprising a frame portion housing a pair of lenses and a pair of temple pieces selectively engaging the frame portion. The temple pieces are configured to allow tool-free connect and disconnect from the frame portion and each comprise a mounting end, an ear engagement end, and a rotating temple body portion positioned between and having a first body side and a second body side which may be alternately orientated outwards by way of rotating the temple body portion. The appearance of the eyeglasses assembly may be altered by way of rotating said rotating temple body portion.

### TECHNICAL FIELD

The present invention relates to a novel configuration of eyeglasses and shoes that provide customization advantages in combination with integrated electronic functionality.

### BACKGROUND OF THE INVENTION

Eyeglasses play a significant role in the fashion industry. Although they are often necessary for the visually impaired, they also provide a fashion statement. As such, the design of eyeglasses plays an important role in fashion. A known and accepted aspect of the fashion industry is that particular styles are in a constant state of flux. What is in vogue at present may be out of style in only a matter of months. For products to adequately weather the ever changing winds of fashion, they must either adopt conservative styling or be adaptable to change with the whims of the fashion industry.

In addition to their role as fashion accessories, it is known that technology may be incorporated into eyeglasses such that microphones, speakers, and cameras can be integrated into the design. Existing integration, however, faces challenges similar to those of the fashion industry. Technology moves and adapts at a quick pace and is increasingly outdated after shorter lifespans. It is therefore increasingly important for products to be technologically adaptable.

An additional problem with the existing integration of technology into eyeglasses is that it commonly runs directly counter to the direction dictated by fashion. A significant impediment for existing tech eyeglasses is that the obvious integration of technology into wearable items is often viewed as tacky. Integration of technology into eyeglasses needs a creative approach such that the integration does not itself diminish fashion appeal.

Additionally, footwear also balances the paradigm of functionality and design. The nature of footwear, however, commonly provides considerably more space than eyewear to house electronics. Therefore, a design concept that also utilized footwear in the integration of technology would be additionally beneficial.

It is an object of the present invention to provide an eyeglass design that is adaptable to conform with fashion industry appeal as well as integrating technology by way of a method that does not diminish the desired styling but may enhance it. It is an additional object of the present design to provide footwear design that integrates technology without diminishing important styling considerations.

### SUMMARY OF THE INVENTION

The present invention provides a unique customizable eyeglasses assembly. The eyeglasses assembly combines a highly customizable fashion frame with a highly customizable integrated electronic functionality. The eyeglasses assembly includes interchangeable temple members including wireless technology integrated within. Additionally, the temple members include at least one rotatable section for altering fashion appearance or for selectively operating the integrated wireless technology. The temple members would preferably have a rotatable stop such that they could be rotatable in place and provide two to four separate appearances.

Also in accordance with an embodiment of the present invention, an interchangeable and rotatable nose piece member may be included into the eyeglasses assembly. The nose piece member may also include integrated technology that interacts with the wireless technology integrated into the temple portions. It is contemplated that the nose piece member may be rotatable or interchanged with additional members to provide multiple fashion appearances or to selectively activate the integrated technology. The temple portions can also be rotated, exchanged, removed or altered for design and/or integrated technological components. As the prescriptions of the lens itself may need to be revised (prescription strength commonly alters over time) the components of the frame and nosepiece can be retained saving costs to the consumer.

Other benefits and features of the present invention will become apparent when viewed in accordance with the following description and drawings, as well as the appended claims.

### BRIEF DESCRIPTION OF THE DRAWINGS

FIG. 1 illustrates an embodiment of an eyeglasses assembly in accordance with the present invention.

FIG. 2 is a detailed illustration of the eyeglasses assembly illustrated in FIG. 1, the detail illustrating a swappable temple piece.

FIG. 3 is an alternate embodiment of the eyeglasses assembly illustrated in FIG. 1.

FIG. 4 is a detailed illustration of the eyeglasses assembly illustrated in FIG. 3, the detail illustrating a swappable temple piece.

FIG. 5 is a detail illustration of the eyeglasses assembly illustrated in FIG. 1, the detail illustrating wireless wifi communication.

FIG. 6 is a detail illustration of the eyeglasses assembly illustrated in FIG. 1, the detail illustrating embedded electronics.

FIG. 7 is an alternate embodiment of the eyeglasses assembly illustrated in FIG. 1, the embodiment showing a plurality of rotating temple body portions, the temple body portions in an off position.

FIG. 8 is a detail of the eyeglasses assembly illustrated in FIG. 7, the detail illustrating a rotating temple body portion in the off position.

FIG. 9 is an embodiment of the eyeglasses assembly in accordance with the present invention, the embodiment showing a plurality of rotating temple body portions, the temple body portions in an on position.

FIG. 10 is a detail of the eyeglasses assembly illustrated in FIG. 9, the detail illustrating a rotating temple body portion in the off position.

FIG. 11 is an alternate embodiment of the eyeglasses assembly illustrated in FIG. 1, the embodiment showing a plurality of rotating temple body portions.

FIG. 12 is an illustration of the eyeglasses assembly illustrated in FIG. 1, the illustration showing the addition of a rotatable nose piece.

FIG. 13 is an illustration of the eyeglasses assembly illustrated in FIG. 12, the nose piece illustrated in a second position.

FIG. 14 is a detailed illustration of a temple piece for use in the eyeglasses assembly illustrated in FIG. 1, the temple piece include a swappable electronics module.

FIG. 14a is a detailed illustration of the temple piece shown in FIG. 1, the temple piece including a telescoping electronics receptacle.

FIG. 14b is a detailed illustration of the temple piece shown in FIG. 1, the temple piece comprising a telescoping temple piece.

FIG. 15 is an alternate embodiment of the temple piece assembly illustrated in FIG. 14, the temple piece include a removable portion.

FIG. 16 is an alternate embodiment of the eyeglasses assembly illustrated in FIG. 1, the embodiment including an electronic ink display.

FIG. 17 is an alternate embodiment of the eyeglasses assembly illustrated in FIG. 1, the embodiment including an extendable antenna.

FIG. 18 is an embodiment of footwear in accordance with the present invention.

FIG. 19 is the footwear illustrated in FIG. 17, the footwear illustrating the selective activation of the embedded electronics.

### DESCRIPTION OF PREFERRED EMBODIMENTS

Although the present invention is described herein with specific reference to particular designs of eyeglasses, it is to be understood that the present invention has applicability to a wide variety of eyeglass designs, including any that would be apparent to persons of ordinary skill in the art upon review of the present description and drawings. The attached schematics are not intended as the sole design application and are directed towards the function and addition of wireless communications teamed up with the fashion/design industries marketability of the same, regardless of the ultimate design. At least one purpose of the present invention was the creation of eyeglasses, worn daily, that incorporate wireless technology and compatible areas with no limitation as to where the glasses might be worn; i.e. entertainment venues, court houses, schools, sports arenas, etc.

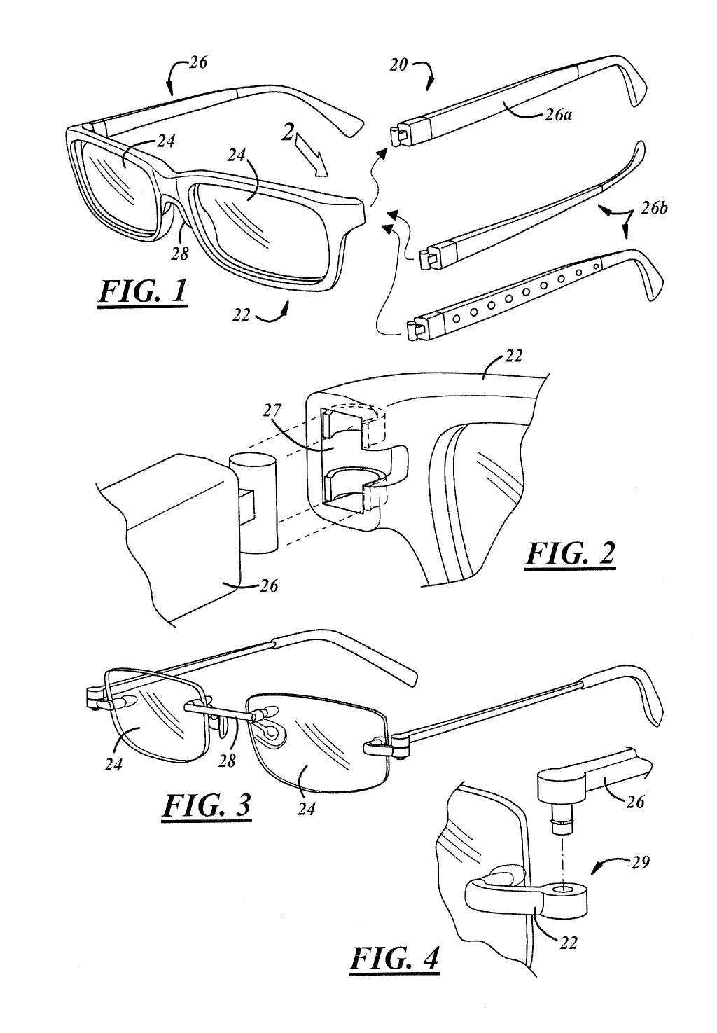

Referring now to FIG. 1, which is an illustration of a pair of eyeglasses 20 in accordance with the present invention. The eyeglasses 20 are comprised of a frame portion 22 housing a pair of lenses 24 and a pair of temple pieces 26. It should be understood, that the eyeglasses 20 in accordance with the present invention may include additional elements such as a nose piece 28. In addition, it is contemplated that the eyeglasses 20 can be utilized without the frame portion 22 wherein the pair of lenses 24 themselves serve as structural support for the temple pieces 26 (see FIGS. 3 and 4). In this embodiment, it is contemplated that the term frame portion is intended to comprise the joint lenses assembly.

The present invention provides a novel approach to eyeglass design in that the temple pieces 26, and also the nose piece 28, are easily removable, alterable, rotatable, interchangeable, and/or swappable from the frame portion 22 or pair of lenses 24. This allows a consumer to alter the appearance or functionality of the eyeglasses 20 while maintaining the pair of lenses 24 that are commonly expensive and/or tailored to an individuals specific needs or prescription. Although it is contemplated that the temple pieces 26 may be made to be removable and swappable in a variety of fashion, in at least one embodiment the present invention contemplates that the attachment methodology includes one of snap fit, standard screw fit, and geometric shape fit. It is contemplated that for geometric shape fit, the temple pieces 26 engage the frame portion 22 with complementary geometric shapes that once rotated into engagement function as a traditional hinge (see FIGS. 1 and 2). FIG. 1 illustrates the removal of an existing temple piece 26a and the replacement with a new temple piece 26b. FIG. 2 illustrates the use of a geometric engagement reservoir 27 by which the temple piece 26b may be inserted horizontally and then rotated into a hinge position. In other embodiments a simple post insertion orientation 29 is contemplated (FIG. 4). Although particular swapping arrangements have been disclosed, a wide variety of swappable configurations would be apparent in light of the present disclosure and the ability to affix the same for functionality and usage predicated on a changing need, application or desire.

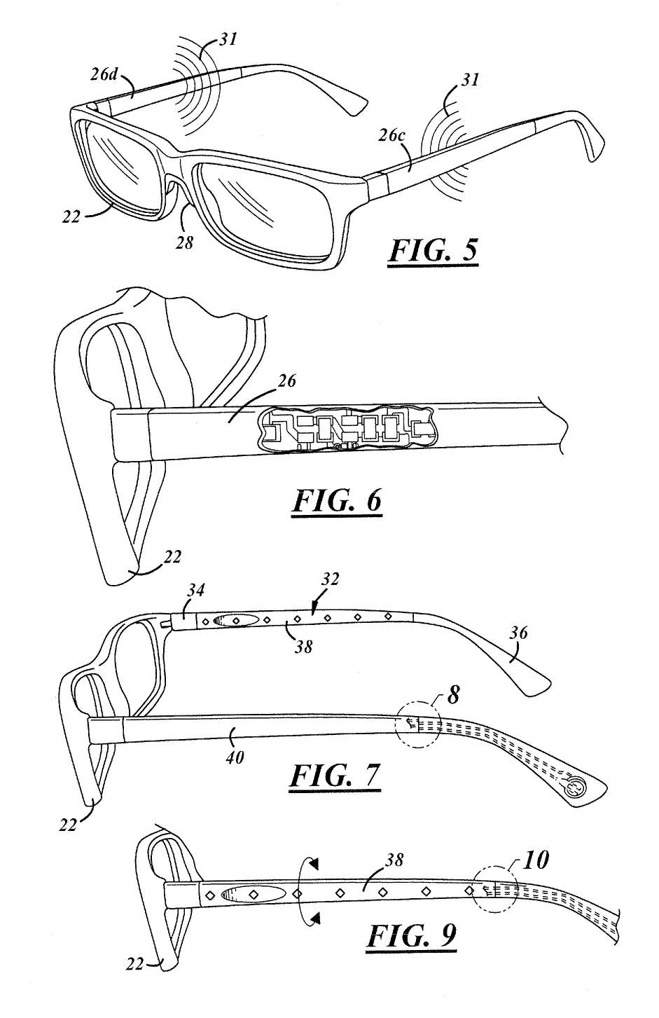

A unique element of the present invention is that the temple pieces 26 are not only swappable but are contemplated to incorporate integrated electronics 30 (FIGS. 5 and 6). Although a variety of integrated electronics 30 are contemplated, at least one embodiment contemplates the use of wifi 31 enabled electronics. In this fashion, individual electronic elements mounted within the left temple piece 26c, the right temple piece 26d and even the nose piece 28 can interact with each other in addition to communicate with external electronics. The ability to disperse electronics 30 into the individual eyeglass components due to their wireless communication allows for the embedding of complex electronics without resulting in bulky temple pieces 26 that would interfere with the fashion qualities so desired by the public. It should be noted that existing technologies incorporating cameras or speakers into eyeglasses commonly result in bulky unfashionable eyewear that has prevented it from being accepted widely. In addition, existing incorporations are subject to severe restrictions on where they may be used and are often prohibited from use altogether. Venues that require restrictions and/or prohibitions include, but are not limited to, entertainment venues, sporting events, legal forums, etc. Existing fixed technology cannot be used in such venues and in so is limited in scope as compared to the present invention. Finally, the present invention allows for independent components to be sold separately or in kit fashion allowing for the interchange and profits to be made on changes in technology, fashion, and even the replacement of batteries.

A secondary issue plaguing existing technology is the need of electronics for consistent power sources during both operation and standby modes. While routine docking for charging purposes is acceptable for items such as cell phones, individuals commonly desire to continuously wear their eyeglasses 20 for an entire day. Power sourcing over this period can result in bulky unfashionable eyewear as well as undesirable weight for the user. The present invention provides solution to this dilemma in a novel and unique fashion. In addition, the ability to change, rotate, or alternate design and function can be utilized to allow the storage of needed charges in other components that may be swapped out.

The present invention contemplates that each of the temple pieces 26c, 26d may include a rotating temple body portion 32 positioned in between the mounting end 34 and an ear engagement end 36. The rotating temple body portion 32 may be rotated 180 degrees such that either a first body side 38 or a second body side 40 is exposed during the wearing of the eyeglasses 20 (FIGS. 7 and 9). The two body sides 38, 40 may be uniquely designed or patterned such that the user can instantaneously alter the appearance of the eyeglasses 20 simply by rotating the temple body portion 32. Thus, the eyeglasses 20 can be altered from casual to dressy or to match a particular outfit virtually instantaneously. It is contemplated that the appearance of the frames may also be altered by way of the absorption of light or by way of photosensitivity based reactions. It is contemplated that the rotating temple body portions 32 may include stops created by snaps, screws, ball/socket devices, push pin releases etc such that the change in rotatable positions may be easily determined and/or fixed by a user even during the process of wearing the glasses.

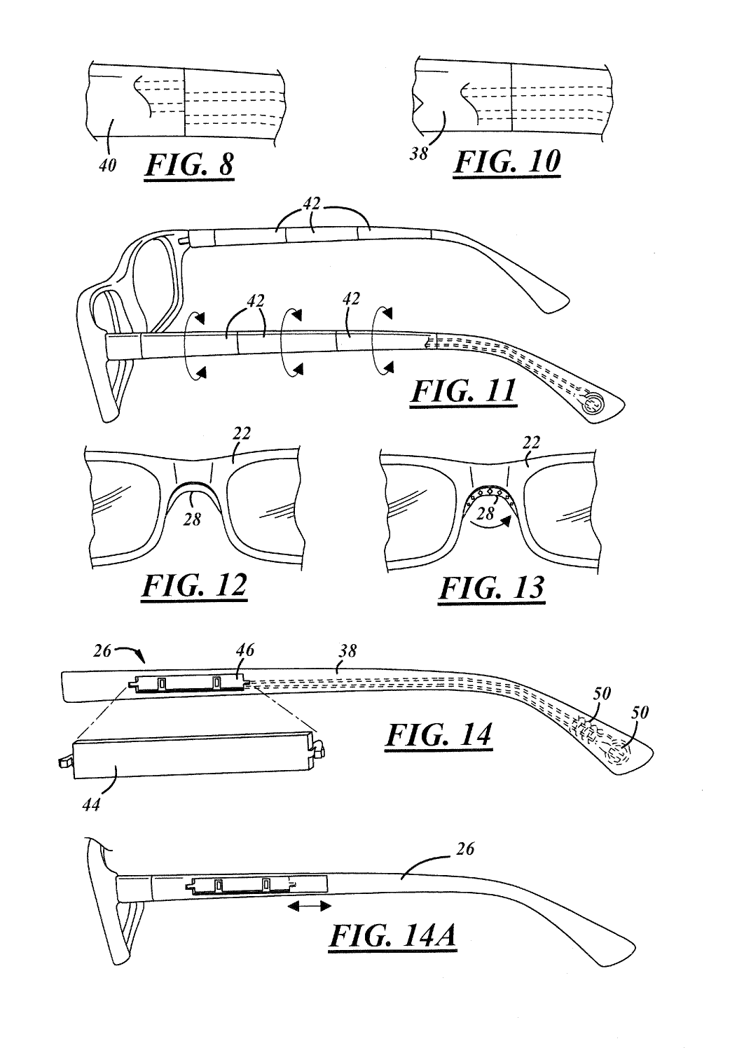

In addition to the instant fashion adjustment, however, the rotatable body portion 32 can provide additional functionality. It is contemplated that the rotatable body portion 32 may be in communication with the integrated electronics 30 such that electronics are powered when the first body side 38 is exposed (FIGS. 9 and 10) and is decoupled from the power supply 41 when the second body side 40 is exposed (FIGS. 7 and 8). In one embodiment it is contemplated that this may be accomplished through the use of asymmetric contact leads 43, 45 that align in one position (FIG. 10) and disengage in a second position (FIG. 8). In this fashion, the user can quickly and efficiently turn on or off the electronics 30 without removing the glasses or aimlessly searching by touch for an on/off switch. In addition to battery savings, the present structure further allows for data security as the user can easily only activate the electronics 30 when in a secure environment. It is contemplated that the two body sides 38, 40 may be textured differently or have a different surface shape such that a user can instantaneously know the power status without removing the glasses. Furthermore, it is contemplated that each of the body sides 38, 40 may actually be composed of a plurality of rotating sections 42 (see FIG. 11) wherein individual functions of the electronics 30 may be individually controlled. In addition, it is contemplated that the nose piece 28 can be rotated at least 180 degrees as well in order to match the change in styles of the body sides 38,40 or to further control the electronics 30 (FIGS. 12 and 13). It should be understood that the described embodiment is only one example of the design and functionality of the present invention. In other embodiments, the rotatable body portion 32 may actually be slid or pushed or even telescopically extended, rather than rotated, to engage the unit and initiate the battery source or to act as a control.

In at least one embodiment, it is contemplated that the electronics 30 are comprised of 3D lens controlling electronics which can be used in combination with 3D lenses such as shutter lenses. The swappable nature of the temple body portions 32 allow a single set of 3D lenses to be operated under a plurality of differing 3D standards. The user would simply swap the temple body portions 32 for those incorporating the appropriate technology for the appropriate use. In another embodiment, it is contemplated that the electronics 30 comprise electronics capable of receiving and storing wireless data transmissions. In this scenario, the owner may rotate the rotating sections 42 to activate the wifi or other receiving electronics. In this fashion, an owner may receive and store vendor contact information or catalogs when at a trade show. Alternately, the detailed lesson notes may be transferred to a student during classroom instruction. In addition, at educational establishments such as museums, details on artwork, science, or history relevant to a particular exhibit maybe transferred to a viewer. A law firm or other professional could utilize this to transfer data. Medical records could be stored and retracted from an individual's glasses for use during treatment or during a medical emergency. This information may comprise information for the user to access at home such as additional data or interne links. This information may further include data to be accessed immediately such as voice data narrating information on the exhibit. In this embodiment, it is contemplated that the electronics 30 includes speakers or earphones. Finally, one embodiment contemplates the storage of personal medical information in the electronics 30 such that a patients medical records may be carried in their entirety with them for emergencies or doctors visits. The ability of the owner to rotate the body sides 38, 40 in order to completely disconnect the electronics 30 allows for a highly secure storage methodology that provides data security above and beyond encryption.

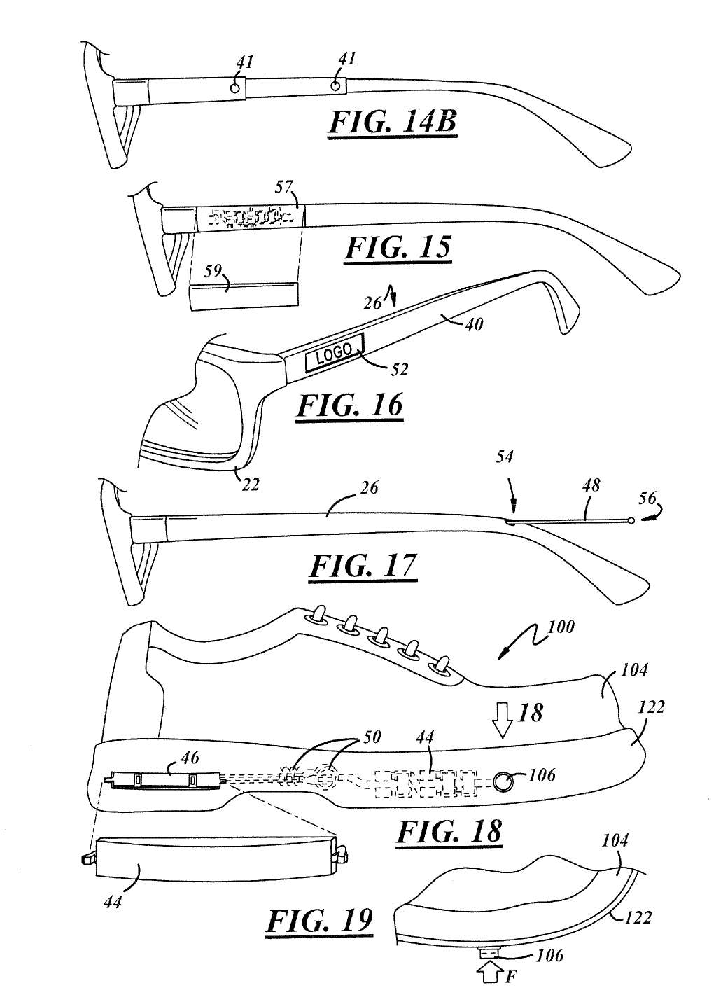

It is contemplated that the electronics 30 may be comprised of a removable electronics module 44 that is configured to be engaged into an electronics receptacle 46 formed in the body sides 38, 40 such that the electronics 30 may be swapped independent of the temple pieces 26 (FIG. 14). In at least one embodiment, it is contemplated that the size of the electronics receptacle 46 may be varied through the use of a telescoping accommodation 47 formed in the body sides 38, 40 (FIG. 14a). Although only the receptacle 46 may be telescoping (FIG. 14a) the enter temple body could also be telescoping (FIG. 14b) to both accommodate differing technologies or for comfort adjustments. It is contemplated that the telescoping features may be fitted together by way of push/pin or other locking assemblies 41 to secure their extension in the correct location. This would allow the receptacle 46 to accommodate a varied number of modules 44 such as battery source, antenna, wireless transmitter, solar technology, etc. In this embodiment, the swapping of electronics 30 or fashion styling may be independent. It is contemplated that the electrics module 44 may be held within the body sides 38, 40 by way of a snap fit such as a groove/teeth arrangement, Velcro, magnets, or similar attachment methodologies. Although the electronics module 44 may be an entirely self contained module, in one embodiment it is contemplated that an antenna 48 and/or battery 50 may be molded or otherwise embedded into the temple pieces 34 independent of the electronics module 44. This allows the electronics module 44 to be reduced in size along with the ability for multiple modules to share a common battery 50 and/or antenna 48. In addition, multiple pairs of temple pieces 26 may be utilized such that one pair remains on a charger while the user places the electronics module 44 in a charged pair. Alternatively, it is contemplated that the electronics module 44 and battery 50 may each be independently swappable. Furthermore, it is contemplated that electronics module 44 or battery 50 may comprise solar power and a solar panel may be incorporated directly into the module 44 or into the temple pieces 26 or nose piece 28 themselves. The solar panels may additionally be utilized for functionality considerations such as allowing the glasses or frames to change color with light sensitivity or for charging the battery 50.

In still another adaptation, it is contemplated that the electronics module 44 may be embedded in a removable mid portion 57 into one of the body sides 38,40 of the temple pieces 26. In such an embodiment, the electronically embedded mid portion 57 may be swapped with an alternate portion having varied electronic functionality or may be replaced with a non-embedded mid portion 59 which is purely esthetic such that the user may operate in areas where electronics are not allowed. The electronics modules 30 may in fact be adapted to fit around the temple pieces 26 and mounted directly to the outside, so as to simultaneously contribute both to functionality and appearance.

In an additional embodiment, it is contemplated that the electronics module 44 comprises an electronic ink controller in communication with an electronic ink display 52 formed in the temple pieces 26 (FIG. 16). The electronic ink display 52 may be used to display the function of the electronics module 44 such that the user may instantly recognize which swappable electronics module 44 is presently installed. In other embodiments, the electronic ink display 52 may be used to display messages or logos. In one embodiment, it is contemplated that the electronic ink display is mounted on the body side 38 or 40 such that it is visible when the electronics module 44 is disconnected (FIG. 16). Since the electronic ink display 52 remains even after power is disconnected, the display can be utilized to communicate which electronics module 44 is installed without actually activating the electronics module 44. Although an electronic ink display 52 has been described, the present invention contemplates the use of a variety of permanent and/or swappable displays mounted within the temple pieces 26.

Although the antenna 48 has been described an illustrated as contained within the temple pieces 26, an additional embodiment contemplates the antenna 48 being movable between an antenna stored position 54 and an antenna deployed position 56 (see FIG. 17). In this embodiment, the antenna 48 may be extended to increase the functional range of the electronics 30. Although the antenna 48 may be deployed in a variety of fashions, in at least one embodiment it is contemplated that the antenna 48 extends from the temple pieces 26 in a direction away from the frame 22. In this way the antenna 48, when in the deployed position 56, extends over the wearer's ear and will be at least partially hidden by the wearer's ear and/or hair. It is contemplated that the temple pieces 26 may be formed with hollow recesses to accommodate the electronics 30 as well as the deployable antenna 48.

The present invention further contemplates the incorporation of the electronics 30 comprising a removable electronics module 44 into footwear 100 (FIGS. 18 and 19). The electronics module 44 is intended to be engaged in an electronics receptacle 46 formed in the footwear 100. In at least one embodiment, it is contemplated that the electronics receptacle 46 is formed in a sole portion 102 of the footwear 100. It is contemplated that the electronics receptacle may also be formed into the shoe body 104. Since it is common for individuals to own multiple pairs of shoes that are designed and styled for a multitude of occasions and activities, it is highly valuable that the electronics 30 may be swapped between pairs. Although the receptacle 46 is illustrated integrated into the sole portion 102, the present invention further contemplates integration into other portions of the footwear 100 where applicable. In addition, although a variety of electronic modules 44 are contemplated, at least one embodiment contemplates the integration of navigation or global positioning electronics with two way communication. This would be highly valuable as a security measure between parents and children or for elderly adults who might need tracking should they get lost.

It is contemplated that the electrics module 44 may be held within the footwear 100 by way of snap fit, Velcro, magnets, or similar attachment methodologies. Although the electronics module 44 may be an entirely self contained module, in one embodiment it is contemplated that an antenna 48 and/or battery 50 may be molded or otherwise embedded into the footwear 100 or sole 102 independent of the electronics module 44. This allows the electronics module 44 to be reduced in size along with the ability for multiple modules to share a common battery 50 and/or antenna 48. In addition, this allows individual pairs of shoes to be stored on a charger such that they are ready for action upon installation of the electronics module 44. It is contemplated that the footwear 100 may incorporate at least one robust pressure switch 106 formed into the sole 102 or other region of the footwear 100. The robust pressure switch 106 may be utilized to selectively engage or disengage the electronics module 44 from the battery 50. It is preferable that the robust pressure switch 106 may be activated by the wearer pressing either with the adjoining shoe or by pressing it against a nearby structure. In this fashion, the wearer can activate the electronics module 44 discreetly and without having to remove the footwear 100. Although the electronics module 44 located in the footwear 100 may act independently, in at least one embodiment, it is contemplated that the electronics in the footwear 100 is in wireless communication with the electronics in the eyewear 20 as described above. The significantly larger structure of footwear 100 allows for an increased level and size of electronics while allowing the eyewear 20 to remain small. In addition the eyewear 20 provides a convenient user interface for the electronics in the footwear 100.

Although footwear 100 can accommodate larger modules, in at least one embodiment it is contemplated that the modules may be identical in size to those used in the temple pieces 24 such that they may be swapped there between. It is further contemplated that the electronics module 44 may be pliable to accommodate the lines of a shoe (heel, toe, etc). The module 44 may be incorporated into a shoe strap. Additionally, a flap might be created to house the electronics module 44 that could snap to the footwear 100 or attach by way of a shoe lace running through the fold over. It is contemplated that the electronics module 44 could be transferred into a wide variety of toys and other objects as well. The present invention, therefore, could be marketed for its transferability to allow wireless technology to accommodate toys, games, key chains and other products not currently wireless compatible. This again could be done through a variety of accommodations including, but not limited to, snaps, zippers, tie ins or other methods.

It is contemplated that the electronics module 44 may comprise gps related technology to allow remote tracking of the wearable element it is embedded in. By placing it in a pet collar, the location of the pet could easily be determined to prevent loss. It could additionally allow for parents to track a child wearing the technology implemented by the present invention. The module 44 could be strategically placed in a child's shoes, clothing, accessories toys, etc to track their whereabouts should they get lost or worse. Prescription medical pill boxes might retain the present invention such that the patient could locate the same should it get lost. Placing the present invention on clothing of an adult with a disability such as dementia could provide tracking without an invasive technique.

It should be understood that the frame portion 22 and the pair of temple pieces 24 or even portions of the footwear 100 may be formed of a variety of materials including floatable and antimicrobial materials. In addition, it is contemplated that the frame portion 22 and temple pieces 24 and even the sole 102 may be formed in a variety of fashions including, but not limited to, injection molding, vacuum forming, and stamping.

While preferred embodiments of the present invention have been shown and described herein, numerous variations and alternative embodiments will occur to those skilled in the art and utilizing advances in technology. Accordingly, it is intended that the invention is not limited to the preferred embodiments described herein but instead limited to the terms of the appended claims.

What is claimed is:

1. A eyeglasses assembly comprising:
a frame portion housing a pair of lenses;
a pair of temple pieces selectively engaging said frame portion, said pair of temple pieces configured to allow tool-free disconnect from said frame portion, each of said temple pieces comprising:
a mounting end configured to selectively engage said frame portion;
an ear engagement end; and
a rotating temple body portion positioned between said mounting end and said ear engagement end, said rotating temple body portion having a first body side and a second body side which may be alternately orientated outwards by way of rotating said temple body portion;
wherein the appearance of the eyeglasses assembly may be altered by way of rotating said rotating temple body portion.

2. The eyeglasses assembly as described in claim 1 further comprising:
at least one electronics assembly positioned within one of said rotating temple body portions, said electronics assembly selectively activated by rotating said temple body portion.

3. The eyeglasses assembly as described in claim 1 further comprising:
a rotating nose piece, said rotating nose pieces having a first nose side and a second nose side which may be alternately orientated outward.

4. The eyeglass assembly as described in claim 1 further comprising:
a rotating nose piece, said rotating nose pieces having a first nose side and a second nose side which may be alternately orientated outward; and
at least one electronics assembly positioned within one of said rotating temple body portions, said electronics assembly selectively activated by rotating said nose piece.

5. The eyeglasses assembly as described in claim 2, wherein said eyeglasses assembly comprises a removable electronics module positioned within one of said rotating temple body portions.

6. The eyeglasses assembly as described in claim 2, wherein said at least one electronics assembly comprises:
a first electronics assembly positioned within a left temple piece; and
a second electronics assembly positioned within a right temple piece;
wherein said first electronics assembly interacts with said second electronics assembly through wireless communication.

7. The eyeglasses assembly as described in claim 2, wherein said at least one electronics assembly comprises a wife enabled electronics assembly.

8. The eyeglasses assembly as described in claim 1, wherein each of said temple pieces comprises:
a plurality of rotating temple body portions.

9. The eyeglasses assembly as described in claim 2, wherein each of said temple pieces comprises:
a plurality of rotating temple body portions, each of said plurality of rotating temple body portions controlling a different function of said electronics assembly.

10. The eyeglasses assembly as described in claim 2, further comprising:
an electronics receptacle formed in said rotating temple body portion, said electronics receptacle configured to selectively engage and retain a removable electronics module.

11. The eyeglasses assemble described in claim 10, wherein said electronics receptacle is adjustable in size to accommodate a range or removable electronics modules.

12. The eyeglasses assembly as described in claim 10, wherein said electronics assembly comprises;
an antenna element embedded in one of said temple pieces;
wherein said removable electronics module is placed in communication with said antenna element when said electronics module is positioned within said electronics receptacle.

13. The eyeglasses assembly as described in claim 10, wherein said electronics assembly comprises;
a battery element embedded in one of said temple pieces;
wherein said removable electronics module is placed in communication with said antenna element when said electronics module is positioned within said electronics receptacle.

14. The eyeglasses assembly as described in claim 10, wherein said removable electronics module is held within said electronics receptacle by way of a magnetic securing element.

15. The eyeglasses assembly as described in claim 2, further comprising:
an electronic ink display mounted on one of said temple pieces, said electronic ink display in communication with said electronics assembly.

16. The eyeglass assembly as described in claim 2, wherein said pair of lenses comprises 3D integrated lenses, said electronics assembly in communication with and in control of said 3D integrated lenses.

17. A method of supplying advance feature eyeglasses comprising:
supplying an eyeglass assembly comprising a frame portion housing a pair of lenses;
supplying a selection of swappable temple pieces configured for tool-less engagement of said frame portion,
said temple pieces comprising:
a mounting end configured to selectively engage said frame portion;
an ear engagement end; and
a rotating temple body portion positioned between said mounting end and said ear engagement end, said rotating temple body portion having a first body side and a second body side which may be alternately orientated outwards by way of rotating said temple body portion;
wherein at last one of said temple pieces includes at least one electronics assembly positioned within one of said rotating temple body portions;
wherein said selection of swappable temple pieces includes a variety of different electronics assemblies providing a range of functions.

18. A method as described in claim 17, wherein said electronics assembly is selectively activated by rotating said temple body portion.

19. A method as described in claim 17, further comprising:
supplying a selection of removable electronics modules, each of said removable electronics modules configured to selectively engage and reside in an electronics receptacle formed in one of said temple pieces.

20. A method as described in claim 17, further comprising:
configuring said first body side and said second body side with differing appearances such that the style of said eyeglass assembly may be altered by rotating said temple body portion.

21. A method as described in claim 19, further comprising:
integrating at least one antenna element into one of said temple pieces, said removable electronics module placed in communication with said antenna element when placed in said electronics receptacle.

22. A method as described in claim 19, further comprising:
integrating at least one battery element into one of said temple pieces, said removable electronics module placed in communication with said antenna element when placed in said electronics receptacle.

23. A method as described in claim 17, wherein said electronics assembly is configured to wirelessly receive or transmit data from an external source.

24. A pair of shoes comprising:
a shoe body;
a sole mounted to said shoe body, said sole including at least one electronics receptacle formed therein; and
at least one electronics module that is removable housed within said electronics receptacle such that is may be easily swapped for varied functionality, said electronics module including wireless communication.

25. A pair of shoes as described in claim 24, further comprising:
a battery element mounted within said sole; and
an antenna element mounted within said sole, said electronics module placed in communication with said battery element and said antenna element when said electronics module is inserted into said electronics receptacle.

26. A pair of shoes as described in claim 25, further comprising:
a robust pressure switch formed into said sole, said robust pressure switch selectively allowing current to flow from said battery to said electronics module.
